(19) United States
(12) Patent Application Publication
(10) Pub. No.: US 2026/0104033 A1
(43) Pub. Date: Apr. 16, 2026

(54) TRANSMISSION ARRANGEMENT AND WIND TURBINE

(71) Applicants: ZF Friedrichshafen AG, Friedrichshafen (DE); ZF Wind Power Antwerpen N.V., Lommel (BE)

(72) Inventor: Srinivasulu Gajjela, Kessel lo (BE)

(21) Appl. No.: 19/353,644

(22) Filed: Oct. 9, 2025

(30) Foreign Application Priority Data
Oct. 14, 2024 (DE) 10 2024 209 953.8

(51) Int. Cl. F03D 15/10; F03D 80/70

(52) U.S. Cl. CPC F03D 15/101; F03D 80/707

(57) ABSTRACT

A transmission for a wind turbine has at least one transmission housing and a planetary gearset arranged therein. A planet carrier of the planetary gearset forms a drive of the transmission. In the wind turbine, the planet carrier is borne on a rotor shaft of the wind turbine. At one end facing a rotor of the wind turbine in the wind turbine, the transmission housing has a radially extending end portion. In addition, the transmission arrangement has a sealing element that seals the radially extending end portion to the planet carrier in order to seal an inner chamber of the transmission housing on a rotor side.

### CROSS REFERENCE TO RELATED APPLICATIONS

This application claims benefit to German Patent Application No. DE 102024209 953.8, filed on October 14, 2024, which is hereby incorporated by reference herein.

### FIELD

The present disclosure relates to a transmission arrangement for a wind turbine. The disclosure also relates to a wind turbine.

### BACKGROUND

Wind turbines are used to generate electricity from wind energy. For this purpose, wind turbines have a rotor. A rotational velocity of the rotor is transmitted to a transmission by a rotor shaft. In the process, the transmission translates the rotational velocity of the rotor shaft into a suitable rotational speed in order to drive a generator. Owing to their size, modern wind turbines are usually transported to the installation site in multiple parts and are only assembled together on site. In the process, parts of the transmission are borne on the rotor shaft, which means that the transmission is not encased, for example in a corresponding transmission housing, until the wind turbine is in the assembled state. Accordingly, during transportation, before construction, and during assembly of the wind turbine, the transmission is often laboriously protected against dirt which may otherwise reduce the service life and efficiency of the wind turbine. Alternatively or additionally, cleaning may also be carried out during assembly, for example by rinsing. This too is complex and expensive.

### SUMMARY

In an embodiment, the present disclosure provides a transmission for a wind turbine including at least one transmission housing and a planetary gearset arranged therein. A planet carrier of the planetary gearset forms a drive of the transmission. In the wind turbine, the planet carrier is borne on a rotor shaft of the wind turbine. At one end facing a rotor of the wind turbine in the wind turbine, the transmission housing has a radially extending end portion. In addition, the transmission arrangement has a sealing element that seals the radially extending end portion to the planet carrier in order to seal an inner chamber of the transmission housing on a rotor side.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a wind turbine, according to an embodiment of the present disclosure;

FIG. 2is a schematic sectional side view of a rotor shaft and a transmission of the wind turbine, according to an embodiment of the present disclosure;

FIG. 3 is a schematic sectional side view of a first embodiment of a transmission arrangement for the wind turbine from Fig. 1, according to an embodiment of the present disclosure;

FIG. 4 is a schematic sectional side view of details of the first embodiment of the transmission arrangement for the wind turbine from Fig. 1, according to an embodiment of the present disclosure; and

FIG. 5 is a schematic sectional side view of details of a second embodiment of the transmission arrangement for the wind turbine from Fig. 1, according to an embodiment of the present disclosure.

### DETAILED DESCRIPTION

A first aspect relates to a transmission arrangement for a wind turbine. By way of example, the wind turbine may have a rotor and a generator. The rotor can drive the generator by means of the transmission in order to generate electrical energy. By way of example, the rotor is connected to the transmission by means of a rotor shaft. The rotor, transmission, and generator may, for example, be fastened to a nacelle of the wind turbine. By way of example, the nacelle may be assembled on a tower either non-rotatably or rotatably. The rotor may have a horizontal or vertical axis of rotation. The rotor may, for example, have two, three, four, or more rotor blades which are connected to the rotor shaft by means of a hub.

The transmission arrangement has a transmission. The transmission has at least one transmission housing. The transmission housing may, for example, have one or more housing elements. The transmission housing may form an inner chamber. The transmission housing may be fastened in the nacelle of the wind turbine. The transmission may have a drive and an output. By way of example, the drive is mechanically operatively connected to the rotor, and the output is mechanically operatively connected to the generator.

The transmission has a planetary gearset arranged in an inner chamber of the transmission housing. Planetary gearsets are, for example, formed as a negative planetary gearset or a positive planetary gearset. By way of example, planetary gearsets have a sun gear, a planet carrier, and a ring gear. The sun gears, planet carriers, and ring gears of planetary gearsets form the rotary elements thereof, for example. Each planetary gearset may have one or more planet gears which are rotatably fastened to the planet carrier. The planet gears may be borne on the planet carrier by means of planet pins. The planet pins may be formed separately from or integrally with a carrier element. The planet gears may be rotatably borne on the planet pins. Alternatively or additionally, the planet pins may be rotatably borne on the carrier element. By way of example, the planet gears of a planetary gearset each mesh with a sun gear and a ring gear of a planetary gearset. An axis of rotation of a planetary gearset may correspond to an axis of rotation of the rotary elements. Relevant planetary gearsets may, for example, be arranged coaxially with the rotor shaft.

The planet carrier of the planetary gearset forms a drive of the transmission. The planet carrier may form an input shaft of the transmission. The planet carrier may be formed in one part or multiple parts. For example, the planet carrier has an axial shaft piece at its end that faces the rotor in the assembled state. By way of example, the planet carrier may be permanently connected to the rotor shaft for conjoint rotation in the assembled wind turbine. For example, the planet carrier and the rotor shaft may have mutually corresponding teeth by means of which the planet carrier and the rotor shaft mate with one another. The rotor shaft and the planet carrier may be arranged coaxially. The ring gear or sun gear may, for example, form the output of the transmission. The transmission may also have a plurality of planetary gearsets that are mechanically operatively interconnected. For example, the output may also be formed by a rotary element of a second planetary gearset. Planetary gearsets can provide high transmission ratios and easily withstand high torques in a space-efficient manner.

In the assembled wind turbine, the planet carrier is borne on a rotor shaft of the wind turbine. In the assembled wind turbine, the planet carrier may be borne solely on the rotor shaft of the wind turbine. For example, the rotor shaft may be borne on the nacelle by means of two roller bearings. Owing to the rotor, high loads may act on the rotor shaft, and so a bearing assembly close to the rotor may allow for smaller bearings. By way of example, the rotor shaft is borne on the nacelle by two rolling bearings. The planet carrier can then be borne on the rotor shaft in a simple manner, for example by a screw connection or press fit. The planet carrier may be directly or indirectly connected to the rotor shaft in order to bear it. By way of example, the planet carrier is not borne on the transmission housing, for example neither directly nor indirectly. The rotor shaft may be part of a transmission arrangement or may be considered to be a separate part therefrom. In the unassembled state, the planet carrier is not borne in the same way as in the operational state, for example. By way of example, the planet carrier is secured to the transmission housing during transportation to the assembly site by clamps, cases, pins, screws, or other clamping elements so as to prevent the transmission from inadvertently shifting position and also being damaged during transportation. During assembly, this securing can be released and corresponding clamping elements removed.

At one end facing a rotor of the wind turbine in the assembled wind turbine, the transmission housing has a radially extending end portion. Here, the end portion may extend as far as the planet carrier, in particular as far as an axial shaft portion of the planet carrier, said portion forming the input shaft. A gap between the radially extending end portion and the planet carrier may have such a width as to be suitable for being sealed by a seal. For example, the gap may be around half the height of a typical O-ring in the same diameter. The radially extending end portion may, for example, be an all-round axial wall. The radially extending end portion may have an annular shape. By way of example, during operation the wall may be substantially free of loads applied by the transmission. The radially extending end region may be non-load-bearing. For example, the radially extending end region may be configured solely for sealing and optionally also for oil guidance in order to lubricate the transmission or even just the planetary gearset. By way of example, the radially extending end region does not have any load-bearing properties. Overall, the wall may, for example, not form a bearing portion for parts of the transmission or wind turbine that rotate during operation. One end of the planet carrier facing the rotor in the assembled wind turbine extends, for example, out of the housing, for example through a central through-opening in the radially extending end portion of the housing. This sub-region of the planet carrier may, for example, be connected to the rotor shaft in the assembled state such that the planet carrier is borne thereon.

The transmission arrangement has a sealing element that seals the radially extending end portion to the planet carrier in order to seal the inner chamber on the rotor side. This sealing may be carried out at least when the wind turbine is in the unassembled state. Thus, the sealing element may seal the inner chamber of the transmission housing prior to the assembled state, for example at least until the rotor shaft is assembled on the planet carrier. After assembly, however, the sealing element may be superfluous since the transmission can be sealed on the rotor side by the bearing of the rotor shaft. The sealing action of the sealing element may be lost during operation. However, the sealing element may also be configured to provide sealing during operation and, in the process, to allow relative rotation of a component such as the planet carrier. By way of example, the sealing element may seal the transmission housing against a housing for bearing the rotor shaft, such as the nacelle or an inner housing separate therefrom. In addition, minor leaks out of the transmission may not be detrimental to the service life and performance, unlike, for example, dirt and water that have infiltrated the transmission before assembly. As a result, there is no need for corresponding covers before assembly, during assembly, and, alternatively or additionally, during transportation. Moreover, the sealing element need not be removed once the wind turbine is assembled or while it is being assembled. This greatly simplifies the transportation and construction of the wind turbine. By way of example, the sealing element continues to be arranged in the transmission even when the wind turbine is in the assembled state.

For example, the sealing element seals a radial gap between the radially extending end portion and the planet carrier, for example by being axially and, alternatively or additionally, radially arranged between the radially extending end portion of the transmission housing and the planet carrier. The sealing element may be contacted directly by the radially extending end portion of the transmission housing. The sealing element may be contacted directly by the planet carrier. However, the sealing element may also provide sealing indirectly, for example by abutting an additional component such as an oil guidance component or a fastening ring by which the sealing element is fastened to the planet carrier and, alternatively or additionally, to the transmission housing. The sealing element may be a separate component. In this case, producing said component may be cost-effective. However, the sealing element may also be formed integrally in other components. For example, the sealing element may be formed on the planet carrier, the transmission housing, or even a ring that holds the planet carrier in the transmission housing during transportation. For example, the sealing element may be injection-molded out of plastics material on an oil guidance component. In this case, the sealing element may not need to be separately assembled.

In one embodiment of the transmission arrangement, it may be provided that the radially extending end portion is configured to supply oil to the planetary gearset in order to lubricate it. For this purpose, the radially extending end portion may have oil guidance ducts, for example. By way of example, the radially extending end portion has one radially extending oil duct. This oil duct is used, for example, for lubricating a plurality or just one of the rotary elements. For example, planet pins of the planet carrier and, alternatively or additionally, planet gears may be lubricated by means of the radially extending end portion. As a result, the transmission arrangement can be compact since the radially extending end portion is used not only for sealing before assembly but also for supplying lubrication oil to the transmission. If a plurality of planetary gearsets are provided, then it is possible to replace, for example, a radially extending oil duct, for example formed by a housing element, between the two planetary gearsets that is otherwise used for lubrication. As a result, the transmission can have a short axial extension.

In one embodiment of the transmission arrangement, it may be provided that the transmission arrangement has an oil guidance element. The oil guidance element may be configured to channel oil from the radially extending end portion to the planet carrier in order to lubricate it. For example, the oil guidance element may additionally axially delimit an oil chamber toward the rotor. By way of example, the oil guidance element may be formed as a plastics component. The oil guidance element may, for example, be screwed to the radially extending end portion. By way of example, the oil guidance element may be assembled after the sealing element and may hold the sealing element. The oil guidance element may also form the sealing element. The oil guidance element may be formed as a fastening ring. For example, the oil guidance element is arranged radially and, alternatively or additionally, axially between the radially extending end portion and the planet carrier. By way of example, the sealing element may abut the oil guidance element and the planet carrier.

In one embodiment of the transmission arrangement, it may be provided that the planet carrier has at least one oil duct which extends axially from one end that faces the rotor in the assembled wind turbine to a planet pin of the planet carrier. As a result, the oil can be guided from the radially extending end portion to the planet carrier. For example, the oil duct may be formed by two sub-portions in the planet carrier. For example, the oil duct may be formed by an axial bore in the planet carrier. The oil duct may also be a duct element such as a pipe. One such oil duct may be provided per planet pin. However, there may be just one oil duct or a different number of oil ducts provided. The oil duct may be used for lubricating the planet carrier. The oil duct may be in fluid communication with the oil guidance element and, alternatively or additionally, with an oil guide in the radially extending end portion.

In one embodiment of the transmission arrangement, it may be provided that the transmission arrangement has an oil recirculation system that faces the rotor in the assembled wind turbine. The oil recirculation system may be configured to guide oil back into the inner chamber of the transmission housing. Thus, oil that has escaped on the rotor side during operation can be conveyed back into the inner chamber of the transmission housing. The oil recirculation system may have corresponding elements for guiding the oil and/or corresponding oil ducts. For example, a rotor-side inlet opening of the oil recirculation system may be arranged radially inwardly in relation to an outlet opening that leads into the inner chamber of the transmission housing. As a result, rotation of the transmission and operation of the wind turbine may have a conveying effect, meaning, for example, that no pump need be provided for recirculating the oil.

In one embodiment of the transmission arrangement, it may be provided that the transmission arrangement has a recirculation element. The recirculation element may be arranged on the rotor side next to the transmission housing outside the inner chamber. The recirculation element may have an oil duct extending radially outward at least in part. Extending radially outward may mean that an inlet opening is arranged radially inwardly in relation to an outlet opening. Oil that has escaped on the rotor side at the inner chamber can be intercepted and fed back into the inner chamber by the recirculation element, for example. The recirculation element may form the sealing element. The recirculation element may hold the sealing element. The sealing element may be arranged between the recirculation element and the planet carrier. The recirculation element may be arranged so as to axially abut the radially extending end portion. By way of example, the recirculation element may be formed as a plastics component. The recirculation element may be in fluid communication with the inner chamber of the transmission housing. For example, the radially extending end portion may have an axial through-opening that places the recirculation element in fluid communication with the inner chamber of the transmission housing. The oil recirculation element may form an axial retention device for the above-described oil guidance element. For example, this axial retention device may be formed as a securing ring that is connected to the planet carrier, for example by a screw connection. Alternatively, a separate securing ring or just one securing ring without an oil recirculation function may also be provided.

In one embodiment of the transmission arrangement, it may be provided that the sealing element provides sealing between the recirculation element and the planet carrier. As a result, the sealing element can be assembled and held in a simple manner. In addition, there is then no need for a seal seat or the like for the sealing element on the transmission housing, for example.

In one embodiment of the transmission arrangement, it may be provided that the radially extending end portion has a through-opening which is configured for recirculating the oil into the inner chamber of the transmission housing. This through-opening extends axially, for example. This through-opening is, for example, arranged radially outside the sealing element and also radially outside a lubrication oil supply.

In one embodiment of the transmission arrangement, it may be provided that the sealing element is formed as a temporary seal. By way of example, a temporary seal does not provide sealing while the wind turbine is in operation or does so only at the start of operation. For example, the sealing element is configured to quickly wear down and lose its sealing action when the assembled wind turbine is in operation. By way of example, the sealing element is not configured for relative movement between the two components that are sealed to one another. For example, the sealing element provides sealing only during transportation and assembly. When the wind turbine is in operation, the temporary sealing element loses its sealing action after just a short amount of time or may, for example, slip off. As a result, the sealing element may be very cost-effective. For example, no more sealing may be needed during operation.

A second aspect relates to a wind turbine. The wind turbine has a rotor. The rotor is, for example, permanently connected to a rotor shaft of the wind turbine for conjoint rotation. The wind turbine has a transmission arrangement according to the first aspect. Respective advantages and further features can be taken from the description of the first aspect, with embodiments of the first aspect also constituting embodiments of the second aspect, and vice versa. The planet carrier is borne on the rotor shaft of the wind turbine. By way of example, the planet carrier may be borne solely on the rotor shaft of the wind turbine. No other bearings then directly support the planet carrier, for example. However, teeth of the planetary gearset, and thus the operative connection to other rotary elements of the planetary gearset, may support the planet carrier at least additionally. The rotor shaft may be permanently connected to the planet carrier of the transmission arrangement for conjoint rotation.

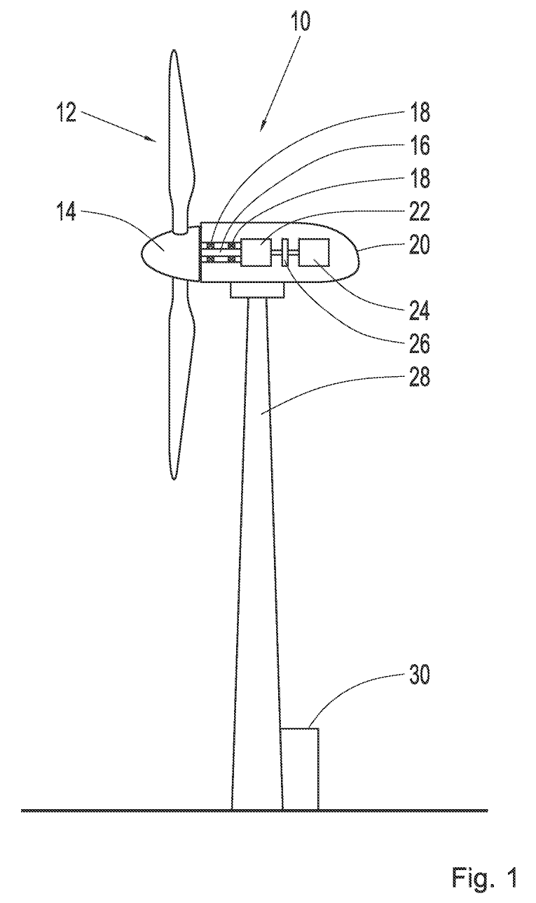

Fig. 1 illustrates a wind turbine 10 in a horizontal design. The wind turbine 10 has a rotor 12, which is held on a rotor shaft 16 by means of a hub 14. The axis of rotation of the rotor shaft 16 extends substantially horizontally. The rotor shaft 16 is borne in a nacelle 20 by means of two rolling bearings 18. The rotor shaft 16 is mechanically operatively connected to a generator 24 by means of a transmission 22. A brake 26 is also arranged in the operative connection between the transmission 22 and the generator 24. The nacelle 20 is rotatably borne on a top end of a tower 28 anchored to the ground. In a further embodiment, the wind turbine 10 is in the form of an offshore installation. Next to the tower 28, the wind turbine 10 also has a grid connection 30.

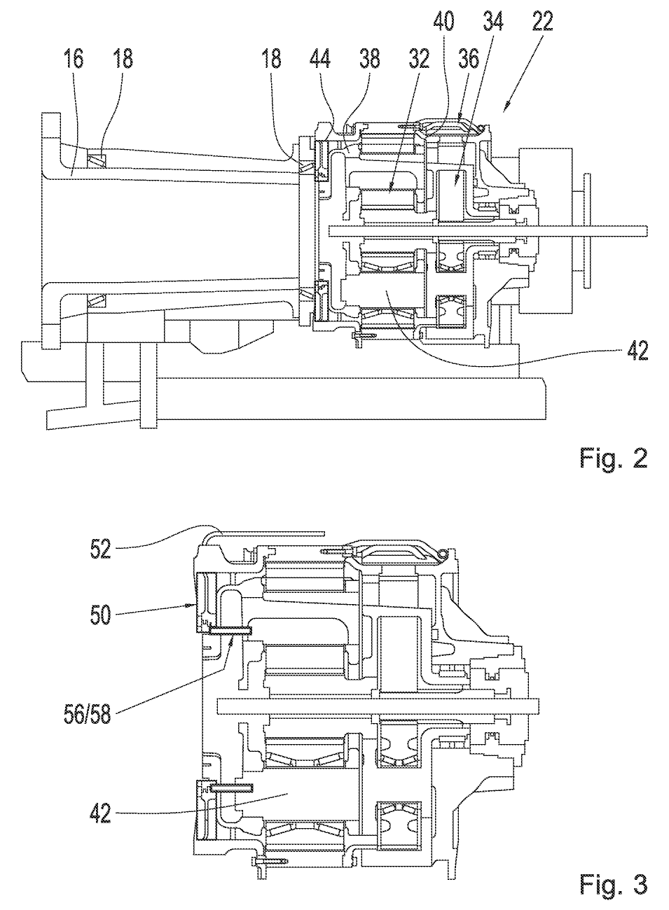

Fig. 2 is a schematic sectional view of a central concept of the present disclosure. Here, the rotor shaft 16 having the two rolling bearings 18 is shown. The transmission 22 is flange-mounted on the rotor shaft 16. In the example shown, the transmission 22 has a first planetary gearset 32 on the rotor side and a second planetary gearset 34 on the generator side. The two planetary gearsets 32, 34 provide a transmission ratio when the torque induced at the rotor 12 by wind is transmitted to the generator 24. The two planetary gearsets 32, 34 are arranged in an inner chamber of the transmission housing 36.

When the wind turbine 10 is assembled, the rotor 12, the rotor shaft 16 having its rolling bearings 18, and the transmission 22 are first transported to an installation site separately and are only assembled together on site. As can be seen in Fig. 2, for example, a planet carrier 38 of the first planetary gearset 32 forms an input shaft of the transmission 22, which is permanently connected to the rotor shaft 16 for conjoint rotation. In this case, the planet carrier 38 of the first planetary gearset 32 is borne solely or at least predominantly by means of the rotor shaft 16. It can also be seen that the transmission housing 36 is open toward the rotor shaft 16 at its rotor-side end region, and the inner chamber of the transmission housing 36 is open here. Therefore, during transportation and also assembly, water, foreign matter, and other dirt may enter here. To prevent such substances from entering, extensive protection may be needed, as well as, alternatively or additionally, rinsing after assembly; this is very laborious.

The transmission housing 36 according to Fig. 2 has an intermediate housing element 40 axially between the two planetary gearsets 32, 34. This intermediate housing element 40 does not have any load-bearing function or provide any surfaces on which to arrange a bearing; however, it does provide a wall extending radially inward. This wall is used for supplying lubrication oil to each planet pin 42 of the planet carrier 38.

To protect the transmission 22 against dirt during transportation and assembly, said wall is moved axially toward the rotor. This is illustrated by lines 44 in Fig. 2. Thus, the wall extending radially inward between the two planetary gearsets 32, 34 can also be omitted, further allowing the transmission 22 to have a short axial extension.

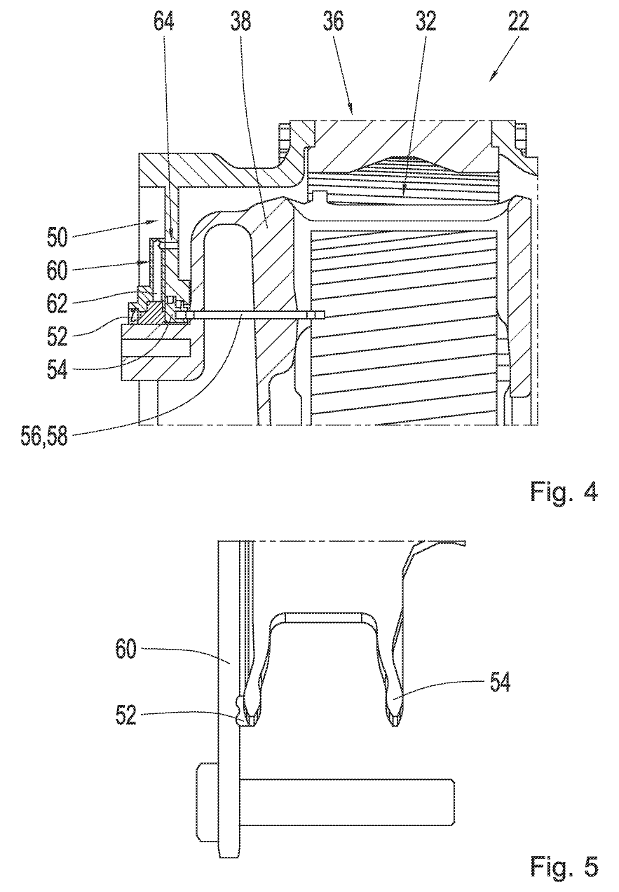

As can be seen in Fig. 3, at one end facing the rotor 12 in the assembled wind turbine 10, the transmission housing 36 has a radially extending end portion 50. This radially extending end portion 50 is used both for supplying lubrication oil to the planet pins 42 of the planet carrier 38 of the first planetary gearset 32 and for sealing the transmission housing 36 on the rotor side at least prior to final assembly. Additionally, a sealing element 52 is provided for that purpose. Details of embodiments of this arrangement are illustrated in Fig. 4 and Fig. 5. In this case, the wind turbine 10 has an oil duct 52, which is elongated toward said end portion 50 and which has previously supplied oil to the intermediate housing element 40.

The radially extending end portion 50 has one or more radially extending through-openings as oil ducts, which are in fluid communication with the oil duct 52. An oil guidance element 54 is arranged radially inside at the radially extending end portion 50 between a shaft portion of the planet carrier 38, which is permanently connected to the rotor shaft 16 for conjoint rotation, and the radially extending end portion 50. The oil guidance element 54 is configured to channel oil from the radially extending end portion 50 to the planet carrier 38 in order to lubricate it. For this purpose, the oil guidance element 54 is formed in a stepped manner on its side facing the radially extending end portion 50. This forms a kind of labyrinth which reduces axial leakage toward the rotor 12. The planet carrier 38 has at least one oil duct 56 that extends axially from one end that faces the rotor 12 in the assembled wind turbine 10 to a planet pin 42 of the planet carrier 38 and, alternatively or additionally, to the planet gears on the planet carrier 38. This oil duct 56 is in fluid communication with the oil guidance element 54. In the present case, the oil duct 56 is formed by two through-holes in two axial wall regions of the planet carrier 38, in which a channeling element 58 is arranged.

On the rotor side, the oil guidance element 54 is axially held by a securing ring 60 that is screwed or otherwise fastened to the radially extending end portion 50. In the first embodiment, this securing ring 60 is formed as a recirculation element 60 that faces the rotor 12 in the assembled wind turbine 10. The recirculation element 60 is part of an oil recirculation system which faces the rotor 12 in the assembled wind turbine 10 and which is configured to guide oil in the region of the rotor shaft 16 and its rolling bearings 18 back into the inner chamber of the transmission housing 36. For this purpose, the recirculation element 60 has an oil duct 62 which extends radially outward at least in part and the inlet opening of which is arranged radially inwardly in relation to an outlet opening. In addition, the oil recirculation system has an axially extending through-opening 64 in the planet carrier 38, said through-opening being arranged radially outwardly in relation to the oil duct 56. The through-opening 64 is in fluid communication with the oil duct 62. In another embodiment, no such oil recirculation system is provided. By way of example, Fig. 4 illustrates such an embodiment.

In the first embodiment, as in Fig. 4, the sealing element 52 is arranged as a separate part radially between the recirculation element 60 and the shaft portion of the planet carrier 38, where it thus seals the transmission housing 36 toward the rotor 12. Alternatively, the sealing element 52 may also directly abut the radially extending end portion 50 or the oil guidance element 54 and then provide sealing in relation to the planet carrier 38. It is also possible for said sealing element to be formed integrally with one of these components.

Fig. 5 illustrates details of a second embodiment without an oil recirculation system. Only differences from the first embodiment will be described here. In the second embodiment, the sealing element 52 is arranged axially between the securing ring 60 and the oil guidance element 54. Here, the sealing element 52 is formed integrally on the oil guidance element 54. Alternatively, the sealing element 52 may also be formed integrally on the securing ring 60. In yet another embodiment, the sealing element 52 is also formed as a separate component here.

In one embodiment, the sealing element 52 is formed as a permanent seal that durably maintains its sealing function even when the wind turbine 10 is in operation. In other embodiments, the sealing element 54 is formed as a temporary seal. Fig. 5 shows such a design by way of example. Owing to relative movement between the securing ring 60 and the oil guidance element 54, the sealing element 52 is quickly rubbed off over a brief period of operation. In this case, the material of the sealing element 52 is selected such that no overheating occurs.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

10 Wind turbine

12 Rotor

14 Hub

16 Rotor shaft

18 Rolling bearing

20 Nacelle

22 Transmission

24 Generator

26 Brake

28 Tower

30 Grid connection

32 First planetary gearset

34 Second planetary gearset

36 Transmission housing

38 Planet carrier

40 Intermediate housing element

42 Planet pin

44 Lines

50 Radially extending end portion

52 Sealing element

54 Oil guidance element

56 Oil duct

58 Channeling element

60 Securing ring / recirculation element

62 Further oil duct

64 Through-opening

1. A transmission arrangement for a wind turbine, comprising:
a transmission, wherein the transmission has at least one transmission housing and a planetary gearset arranged in an inner chamber of the transmission housing,
wherein a planet carrier of the planetary gearset forms a drive of the transmission,
wherein, in wind turbine, the planet carrier is borne on a rotor shaft of the wind turbine,
wherein, at one end facing a rotor of the wind turbine in the wind turbine, the transmission housing has a radially extending end portion, and
wherein the transmission arrangement has a sealing element that seals the radially extending end portion to the planet carrier in order to seal the inner chamber on a rotor side.

2. The transmission arrangement according to claim 1, wherein the radially extending end portion is configured to supply oil to the planetary gearset in order to lubricate it.

3. The transmission arrangement according to claim 2, wherein the transmission arrangement has an oil guidance element configured to channel oil from the radially extending end portion to the planet carrier in order to lubricate it.

4. The transmission arrangement according to claim 2, wherein the planet carrier has at least one oil duct which extends axially from the one end that faces the rotor in the wind turbine to a planet pin of the planet carrier.

5. The transmission arrangement according to claim 2, wherein the transmission arrangement has an oil recirculation system that faces the rotor in the wind turbine and which is configured to guide oil back into the inner chamber of the transmission housing.

6. The transmission arrangement according to claim 5, wherein the transmission arrangement has a recirculation element which is arranged on a rotor side next to the transmission housing outside the inner chamber and which has an oil duct extending radially outward at least in part.

7. The transmission arrangement according to claim 6, wherein the sealing element provides sealing between the recirculation element and the planet carrier.

8. The transmission arrangement according to claim 5, wherein the radially extending end portion has a through-opening which is configured for recirculating the oil into the inner chamber of the transmission housing.

9. The transmission arrangement according to claim 1, wherein the sealing element is formed as a temporary seal.

10. A wind turbine comprising a rotor, which is permanently connected to a rotor shaft for conjoint rotation, and the transmission arrangement according to claim 1, wherein the planet carrier is borne on the rotor shaft of the wind turbine.
